(19) United States
(12) Patent Application Publication
(10) Pub. No.: US 2011/0141428 A1
(43) Pub. Date: Jun. 16, 2011

(54) PROCESS FOR PRODUCING SPACER FOR LIQUID CRYSTAL DISPLAY APPARATUS, INK FOR SPACER FORMATION, LIQUID CRYSTAL DISPLAY APPARTUS AND PROCESS FOR MANUFACTURING THE SAME

(76) Inventors: Naoki Maruyama, Ibaraki (JP); Kazunori Yamamoto, Ibaraki (JP); Yasushi Kumashiro, Ibaraki (JP); Masashi Yamaura, Ibaraki (JP)

(21) Appl. No.: 12/676,704

(22) PCT Filed: Oct. 3, 2007
(86) PCT No.: PCT/JP2007/069359

§ 371 Date: Oct. 27, 2010

(30) Foreign Application Priority Data
Sep. 5, 2007 (JP) 2007-230165

(51) Int. Cl. G02F 1/1339

(52) U.S. Cl. 349/156

(57) ABSTRACT

A process for producing a spacer for a liquid crystal display apparatus whereby an ink-jet method is used to print droplets composed of an ink that contains a resin and a solvent that dissolves it but that contains essentially no solid particles on a substrate 23, and the solvent is removed from the droplets on the substrate 23 to form a spacer 11 situated at a prescribed location on the substrate 23, wherein A in the following formula (1) is −10 to 15 mJ/m², where X mN/m is the surface tension of the ink at 25° C. and Y mJ/m² is the surface free energy of the substrate 23 at 25° C.

A=X−Y (1)

### TECHNICAL FIELD

The present invention relates to a process for producing a spacer for a liquid crystal display apparatus, to an ink for spacer formation, and to a liquid crystal display apparatus and a method for manufacturing the same.

### BACKGROUND ART

Liquid crystal display apparatuses have come into use in recent years as display devices, such as color television sets and monitors for personal computers. Liquid crystal display apparatuses generally have a construction in which a pair of transparent substrates with transparent electrodes and other components are laid facing each other across a gap of 1-10 μm, and a liquid crystal substance is sealed between the substrates to form a liquid crystal layer. An electric field is then applied to the liquid crystal layer through the electrodes to orient the liquid crystal substance, and transmission and non-transmission of backlight rays is controlled by the orientation of the liquid crystal substance to display an image.

Because a non-uniform thickness of the liquid crystal layer in a liquid crystal display apparatus produces display irregularities and contrast anomalies, it is essential to maintain a constant gap between the substrates for a uniform liquid crystal layer thickness. For this reason, in the past, silica particles, metal oxide particles or beads of thermoplastic resin particles, having a uniform particle size distribution, have been dispersed on the substrates as spacers between the substrates in order to maintain a consistent gap between the substrates.

However, since the beads are not anchored in conventional methods that use dispersed beads as spacers (particulate spacers), vibrations propagated in the liquid crystal display apparatus can displace the beads and cause display irregularities. In addition, because it is difficult to precisely situate beads at the desired location during dispersion, the distribution tends to have variation and in some cases the beads may become located in the display area of the liquid crystal display apparatus, whereby the beads can cause display defects such as display irregularities and light dropouts.

Photolithography methods using photosensitive resins have been studied as methods for forming a spacer on one of the two substrates. Such methods allow formation of resist patterns with high positional precision, as spacers with the desired placement. Since the adhesive force of a resist pattern on a substrate is relatively high in most cases, it is considered superior for improving poor orientation or reduced contrast, compared to using a particulate spacer.

Such photolithographic methods, however, require removal of the undesired sections after the entire substrate surface has been coated with a photosensitive resin as the spacer material, thus increasing material loss, while numerous steps are also necessary for development and release, thus creating a more complex manufacturing process. In addition, a photolithography plate suitable for each product must be prepared, and this also complicates the process. Furthermore, with increasing sizes of liquid crystal display apparatuses in recent years, it is becoming more difficult to evenly coat the spacer materials and prepare suitable plates.

On the other hand, methods of printing on substrates by ink-jet methods using particulate spacer-containing inks have been investigated as methods of placing particulate spacers (beads) on substrates (Patent documents 1-4). Ink jet methods can form spacers by simpler procedures than photolithographic methods. They also allow drastic improvement in positional precision compared to methods of dispersing a particulate spacer. For example, using an ink-jet method for local printing of an ink comprising a particulate spacer dispersed in a solvent in the black matrix sections of a color filter as the non-display area, and evaporation of the solvent from the printed ink, allows selective formation of the particulate spacer on the black matrix.
[Patent document 1] Japanese Unexamined Patent Publication HEI No. 11-316380
[Patent document 2] Japanese Unexamined Patent Publication No. 2002-333631
[Patent document 3] Japanese Unexamined Patent Publication No. 2004-13116
[Patent document 4] Japanese Unexamined Patent Publication No. 2003-295198

### DISCLOSURE OF THE INVENTION

### Problems to be Solved by the Invention

Research by the present inventors has shown that a spacer for a liquid crystal display apparatus can be formed with sufficiently high positional precision by using an ink containing essentially no solid particles but containing a resin and a solvent dissolving it, instead of an ink containing solid particles.

However, when a spacer for a liquid crystal display apparatus is formed using an ink containing essentially no solid particles, it is difficult to form a spacer with sufficient height precision. That is, it has been difficult to adequately inhibit variation in the spacer height if the ink contains no solid particles.

The present invention has been accomplished in light of these circumstances, and it is an object thereof to provide a process for producing a liquid crystal display spacer which can form a liquid crystal display spacer with sufficient height and satisfactorily excellent positional precision and height precision. It is another object of the invention to provide an ink for spacer formation that can be suitably used in the aforementioned production process, as well as a liquid crystal display apparatus comprising a spacer for a liquid crystal display apparatus formed by the production process and a method for manufacturing the same.

### Means for Solving the Problems

In order to achieve the objects stated above, the invention provides a process for producing a spacer for a liquid crystal display apparatus comprising the steps of printing a substrate with droplets composed of an ink that contains a resin and a solvent that dissolves it but that contains essentially no solid particles by an ink-jet method, and removing the solvent from the droplets on the substrate to form a spacer situated at a prescribed location on the substrate, wherein A in the following formula (1) is −10 to 15 mJ/m², where X mN/N is the surface tension of the ink at 25° C. and Y mJ/m² is the surface free energy of the substrate at 25° C.

A=X−Y (1)

Since an ink-jet method is employed in this production process of the invention, it is easier to form a spacer for a liquid crystal display apparatus. Moreover, since the ink used contains essentially no solid particles, it is possible to form a spacer for a liquid crystal display apparatus with satisfactorily excellent positional precision. In addition, a sufficient height H can be obtained with minimal variation in the height H.

The following is conjectured to be the reason that allows formation of a spacer with sufficient height, satisfactorily excellent positional precision and minimal variation in the height H. Specifically, if the wettability of an ink for a substrate is too high, it is difficult to form a spacer with a height H of 1 μm or greater that is suitable for a spacer for a liquid crystal display apparatus. In addition, the spacer diameter is increased and it becomes difficult to form the spacer in the desired printing area. If the wettability of the ink for the substrate is too low, on the other hand, the droplets will be repelled after they have been placed by the ink-jet method, potentially preventing formation of the spacer at the desired position. Even with the same ink, a different surface free energy on the substrate will result in different ink wettability and hence a variable spacer height H. Thus, by limiting the difference (A) between the ink surface tension and substrate surface free energy to the range of −10 to 15 mJ/m², it is possible to form a spacer with a sufficient height, satisfactorily excellent positional precision and with minimal height H variation.

In a conventional production process in which an ink containing a particulate spacer is printed by an ink-jet method, the uniformity of the ink interface (meniscus) shape at the ink-jet nozzle tip is disturbed by the presence of solid particles such as a particulate spacer, and as a result the flight path of the discharged droplets becomes curved and the discharge speed is irregular. A curved flight path and irregular discharge speed of the droplets lowers the impact positional precision and generates satellites. According to the invention, however, an ink containing essentially no solid particles is used and the difference (A) between the surface free energy of the substrate and the surface tension of the ink is adjusted, thus allowing formation with excellent positional precision of the spacer and high precision of the spacer height H.

Preferably, A in formula (1) is varied within the range of −10 to 15 mJ/m² as specified by the invention to adjust the height H of the spacer for a liquid crystal display apparatus. Adjusting A to within this range will allow the spacer height H to be adjusted with satisfactorily excellent precision while maintaining sufficient height H.

According to the invention, the surface tension of the ink at 25° C. is preferably 20 mN/m or greater. Also, the viscosity of the ink at 25° C. is preferably no greater than 50 mPa·s. Using an ink with these properties will facilitate reduction in the diameter of the droplets placed on the substrate and thus the size of the spacer that is formed. Spacer size reduction is essential, especially for a high definition liquid crystal display apparatus. The ink can also inhibit ink-jet clogging so that satisfactory printing properties can be obtained. Such an ink is particularly useful when employing a method of printing ink two or more times at the same location.

According to the invention, the vapor pressure of the solvent in the ink at 25° C. is preferably less than 1.34×10³ Pa. This can satisfactorily inhibit increase in the ink viscosity that occurs with evaporation of the solvent, and thus further prevent clogging of the ink-jet.

According to the invention, the resin in the ink is preferably a thermosetting resin. Because the viscosity of the thermosetting resin before curing is relatively low, using a thermosetting resin lowers the viscosity of the ink to result in a more stable discharge property. In this case, the spacer for a liquid crystal display apparatus can be formed by heating the droplets on the substrate to remove the solvent from the droplets while curing the thermosetting resin.

According to the invention, the thermosetting resin preferably comprises an epoxy resin and its curing agent. By appropriate selection of the type of epoxy resin and curing agent, the cured product composing the spacer can be imparted with desired properties relatively easily. From the viewpoint of heat resistance and adhesion, the epoxy resin is preferably a glycidyl ether compound obtained as the condensation product of a phenol compound and an aldehyde compound.

According to the invention, the filtered solid content of the ink when it has been filtered with a 1 μm aperture filter is preferably less than 0.3 mass % with respect to the ink. This will further improve the positional precision of the spacer for a liquid crystal display apparatus that is to be formed.

Also according to the invention, the height H of the spacer for a liquid crystal display apparatus is preferably adjusted to the desired height (about 1-10 μm) by varying the solid content of the dried ink. The solid content of the dried ink (%) may be adjusted to any value within a viscosity range of up to 50 mPa·s at 25° C. The solid content of the ink can be calculated by the following formula (2). The dry weight in the following formula (2) is the weight after drying the ink at 200° C. for 30 minutes.

Solid content (%)=(dry weight/ink weight before drying)×100 (2)

According to the invention, the height H of the spacer for a liquid crystal display apparatus may also be adjusted by varying the ink droplet volume. The ink droplet volume is preferably 0.001-100 pL, more preferably 1-80 pL and even more preferably 1-30 pL. A greater droplet volume will tend to increase the diameter of the formed spacer and further restrict the printing position.

According to another aspect, the invention relates to a spacer ink for a liquid crystal display apparatus. According to the invention there is provided an ink for spacer formation for a liquid crystal display apparatus, which is printed on a substrate by an ink-jet method and contains a resin and a solvent that dissolves it but contains essentially no solid particles, wherein A in general formula (1) above is −10 to 15 mJ/m², where X mN/m is the surface tension of the ink at 25° C. and Y mJ/m² is the surface free energy of the substrate at 25° C.

Using such an ink for spacer formation allows formation of a spacer of sufficient height H for a liquid crystal display apparatus. The spacer formed by the ink for spacer formation has sufficiently excellent positional precision and high precision.

Using an ink for spacer formation of the invention also allows control of the spacer height H to satisfactorily high precision. The ink for spacer formation of the invention is used to form a spacer for a liquid crystal display apparatus by printing droplets of the ink by an ink-jet method on a substrate. Stated differently, the ink for spacer formation of the invention is suitable for use in the process for producing a spacer for a liquid crystal display apparatus according to the invention. The ink for spacer formation of the invention allows a spacer for a liquid crystal display apparatus to be formed with sufficiently high positional precision and excellent height precision, by a simple process.

According to yet another aspect, the invention relates to a process for producing a liquid crystal display apparatus that comprises a pair of mutually opposing substrates and a liquid crystal layer and spacer for a liquid crystal display apparatus situated between the pair of substrates. The process for producing a liquid crystal display apparatus according to the invention comprises a step of forming a spacer for a liquid crystal display apparatus on at least one of the substrates by the production process of the invention.

According to the production process of the invention it is possible to form a spacer for a liquid crystal display apparatus of sufficient height H with satisfactorily excellent positional precision and height precision. Such a spacer for a liquid crystal display apparatus can be easily formed by a simple process.

According to yet another aspect, the invention relates to a liquid crystal display apparatus. The liquid crystal display apparatus of the invention comprises a pair of mutually opposing substrates and a liquid crystal layer and spacer for a liquid crystal display apparatus situated between the pair of substrates. The spacer for a liquid crystal display apparatus is formed by the production process of the invention.

The liquid crystal display apparatus of the invention has a spacer of sufficient height H placed with satisfactorily excellent positional precision and height precision. It is thus possible to adequately inhibit display defects such as display irregularities and light dropouts.

### Effect of the Invention

According to the invention it is possible to provide a process for producing a liquid crystal display spacer which can form a liquid crystal display spacer with sufficient height and satisfactorily excellent positional precision and height precision. The invention can also provide an ink for spacer formation that can be suitably used in the aforementioned production process, as well as a liquid crystal display apparatus comprising a spacer for a liquid crystal display apparatus formed by the production process and a method for manufacturing the same.

Moreover, the spacer height can be controlled to any height and the spacer for a liquid crystal display apparatus can be formed with sufficiently high positional precision by a simple process. Since a spacer of the desired height can be selectively formed on the non-display areas of the liquid crystal display apparatus with high precision, it is possible to adequately minimize display defects such as display irregularities and light dropouts in the liquid crystal display apparatus.

Furthermore, whereas conventional particulate spacers have had small contact areas due to point contact with the substrate, a spacer formed by the production process of the invention allows the contact area with the substrate to be increased. Since adhesiveness between the substrate and the resin composing the spacer will generally be high, it becomes possible to obtain satisfactory adhesiveness between the spacer and substrate.

### BRIEF DESCRIPTION OF THE DRAWINGS

FIG. 1 is a schematic cross-sectional view showing an embodiment of a spacer for a liquid crystal display apparatus formed on a substrate by the process for producing a spacer for a liquid crystal display apparatus according to the invention.

FIG. 2 is a schematic cross-sectional view showing another embodiment of a spacer for a liquid crystal display apparatus formed on a substrate by the process for producing a spacer for a liquid crystal display apparatus according to the invention.

FIG. 3 is a top view of the spacer 12 of FIG. 2.

FIG. 4 is a schematic cross-sectional view of an embodiment of a liquid crystal display apparatus according to the invention.

### EXPLANATION OF SYMBOLS

1: Liquid crystal display apparatus, 2a, 2b: electrode, 3a, 3b, 23: substrate, 23a: main side, 5a, 5b: polarizing plate, 6a, 6b: substrate member, 7: color filter, 8: retardation film, 9: backlight, 10, 11, 12: spacer, 13: sealant, 17a, 17b: orientation layer, 18: liquid crystal layer, 20, 22: resin layer.

### BEST MODE FOR CARRYING OUT THE INVENTION

Preferred embodiments of the invention will now be described in detail. However, the present invention is not limited to the embodiments described below.

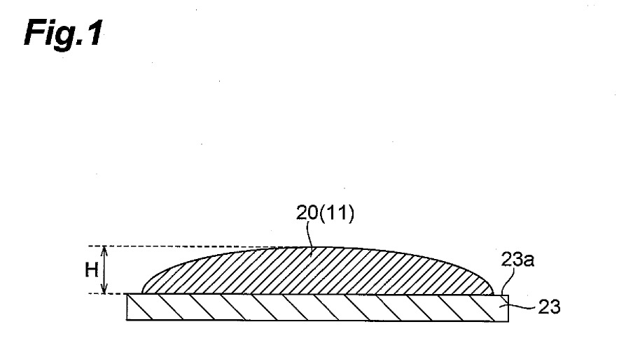

FIG. 1 is a schematic cross-sectional view showing an embodiment of a spacer for a liquid crystal display apparatus formed on a substrate by the process for producing a spacer for a liquid crystal display apparatus according to the invention. The spacer for a liquid crystal display apparatus 11 composed of a resin layer 20 is provided on the main side 23a of a substrate 23. The process for producing the spacer for a liquid crystal display apparatus 11 will now be explained.

In the process for producing the spacer for a liquid crystal display apparatus of this embodiment, droplets composed of an ink containing a resin and a solvent that dissolves it and containing essentially no solid particles, is printed on the main side 23a of the substrate 23 by an ink-jet method, and the solvent is removed from the droplets on the main side 23a of the substrate 23 to form a spacer for a liquid crystal display apparatus situated at the prescribed position on the main side 23a. A in formula (1) above is −10 to 15 mJ/m², where X mN/N is the surface tension of the ink at 25° C. and Y mJ/m² is the surface free energy of the substrate at 25° C.

In the process for producing the spacer for a liquid crystal display apparatus of this embodiment, first the main side 23a of the substrate 23 to be used in the liquid crystal display apparatus is printed with an ink containing a resin and a solvent that dissolves the resin and containing essentially no solid particles, by an ink-jet method. The solvent is removed by heat treatment, for example, to form the resin layer 20. It is thus possible to form a spacer for a liquid crystal display apparatus 11 comprising the resin layer 20 on the substrate 23. The height H of the spacer 11 is preferably 1-10 μm.

The ink-jet method used may employ a common discharge process such as, for example, a piezo system wherein the liquid is discharged by vibration of a piezo element, or a thermal system wherein expansion of the liquid by rapid heating is utilized for discharge of the liquid. Ordinary ink-jet apparatuses may be used for such ink-jet methods.

An example of a method for removing the solvent after the ink has impacted onto the substrate 23 is a method of heat treatment by heating the substrate or blowing hot air onto it. Such heat treatment may be carried out, for example, at a heating temperature of 150-250° C. for a heating time of 0.2-1.0 hours. When a thermosetting resin is used as the resin, the resin may be cured after removal of the solvent or simultaneously with removal of the solvent.

The difference (A) between the surface tension X mN/N of the ink and the surface free energy Y mJ/m² of the substrate 23 is −10 to 15 mJ/m² and preferably −10 to 0 mJ/m². If A is within the range of −10 to 0 mJ/m², the spacer 11 will be appropriately flattened (spacer 11 diameter/height H=10-30), and the standard deviation of the height H of the spacer 11 can be lowered to within 0.05 μm. If A is less than −10 mJ/m² it will not be possible to form a spacer with sufficient height. If A is greater than 15 mJ/m², on the other hand, it will not be possible to form the spacer 11 at the prescribed location. The diameter of the spacer 11 is the diameter at the contact interface with the main side 23a of the substrate 23.

The surface free energy of the substrate 23 is preferably no greater than 60 mJ/m², more preferably no greater than 35 mJ/m² and even more preferably no greater than 30 mJ/m². The surface free energy of the substrate can be adjusted by changing the material of the substrate surface. By thus selecting the material of the substrate surface it is possible to adjust the resin layer 20 height, or in other words the height H of the spacer 11.

The ink for spacer formation of this embodiment preferably has a surface tension of 20 mN/m or greater. If the surface tension of the ink for spacer formation is less than 20 mN/m, the ink droplets will spread out after impacting the substrate 23, thus tending to hamper formation of the spacer within the narrow-width non-display area of the liquid crystal display apparatus. The surface tension of the ink for spacer formation is more preferably in the range of 20-80 mN/m. This is because an ink surface tension exceeding 80 mN/m will tend to produce ink-jet nozzle clogging.

The surface tension of the ink can be adjusted by varying the mixed resin components, the type of solvent and the mixing ratio. By thus modifying the ink composition it is possible to adjust the heights of the droplets printed on the main side 23a of the substrate 23.

It is generally easier to lower the surface tension of ink than to increase it. A lower surface free energy of the substrate 23 can widen the variation width for the difference between the surface tension of the ink and the surface free energy of the substrate 23, thus allowing a wider range of control of the height H of the spacer 11 that is formed. A larger positive value for the difference (A) between the surface tension X of the ink and the surface free energy Y of the substrate 11 can increase the height H of the spacer 11.

The height H of the spacer for a liquid crystal display apparatus 11 can be adjusted by controlling the heights of the droplets printed on the main side 23a of the substrate 23 by the ink-jet method. The droplet heights can be adjusted by varying the ink surface tension, the surface free energy of the substrate 23, the droplet volume, and the dry solid content calculated by formula (2) above. The “heights” of the spacer and the droplets for this embodiment are the thicknesses of the spacer and droplets in the vertical direction of the main side 23a of the substrate 23.

According to this embodiment, heights of the droplets on the main side 23a of the substrate 23 can be adjusted by varying the difference between the surface tension X mN/N of the ink and the surface free energy Y mJ/m² of the substrate 23, or in other words the value of A calculated by formula (1) above, within the range of −10 to 15 mJ/m². By removing the solvent from the droplets for curing, it is possible to form a spacer for a liquid crystal display apparatus 11 having the desired height H, with sufficient precision.

In the process for producing a spacer for a liquid crystal display apparatus according to this embodiment, the height H of the spacer 11 can be adjusted by varying the ink droplet volume or the dry solid content of the ink (the value calculated by formula (2) above). A larger ink droplet volume and a higher dry solid content of the ink can increase the height H of the spacer 11.

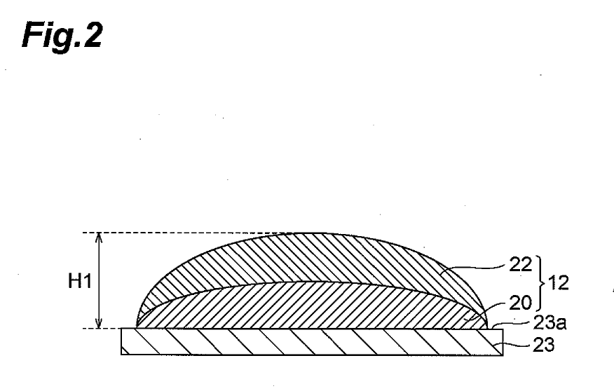

FIG. 2 is a schematic cross-sectional view showing another embodiment of a spacer for a liquid crystal display apparatus formed on a substrate by the process for producing a spacer for a liquid crystal display apparatus according to the invention. A spacer for a liquid crystal display apparatus 12 having the resin layer 20 and resin layer 22 laminated in this order is formed on the substrate 23. The process for producing the spacer for a liquid crystal display apparatus 12 will now be explained.

First, droplets composed of ink containing a resin and a solvent and containing essentially no solid particles are discharged for printing on the main side 23a of the substrate 23 by an ink-jet method. The difference (A) between the surface tension of the ink used and the surface free energy of the substrate 23 is in the range of −10 to 15 mJ/m². The solvent is removed from the droplets formed in this manner and curing is performed to form the resin layer 20. An ink containing a resin and a solvent and containing essentially no solid particles is printed on the resin layer 20 by an ink-jet method. Specifically, the ink for spacer formation is printed at the same location as the location where the resin layer 20 is formed on the substrate 23. The ink may have the same composition as the ink used for formation of the resin layer 20, or it may have a different composition. After the ink has thus been printed on the resin layer 20, the solvent is removed in the same manner as formation of the resin layer 20, to form a resin layer 23 on the resin layer 20. This allows a spacer for a liquid crystal display apparatus 12 to be formed having a resin layer 20 and a resin layer 22 laminated in that order on the substrate 23, as shown in FIG. 2. The height H1 of the spacer 12 obtained by the production process of this embodiment is a sufficient height for a spacer for a liquid crystal display apparatus.

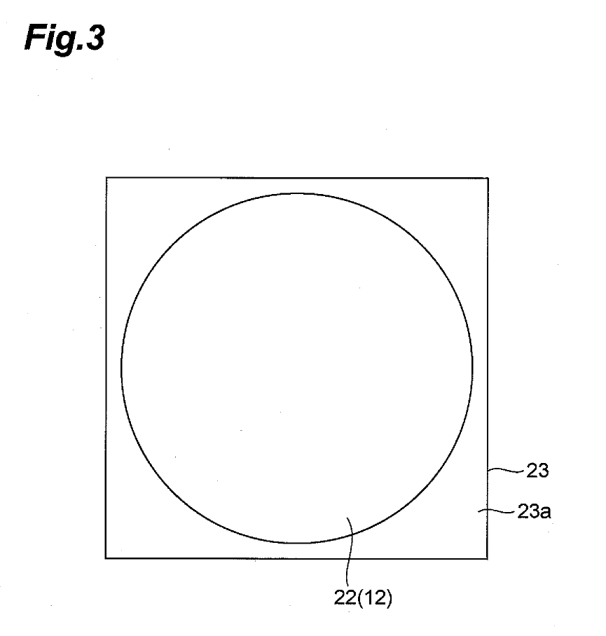

FIG. 3 is a top view of the spacer 12 of FIG. 2. The resin layer 22 is provided covering the resin layer 20 (FIG. 2). The ink for spacer formation of the invention can thus be discharged more than once in a single formation area. This allows formation of a spacer for a liquid crystal display apparatus that is easily adaptable for the gap heights of a wide range of liquid crystal layers.

The substrate 23 is a substrate used in a liquid crystal display apparatus, and for example, it may be one having an electrode or orientation layer on the side on which the spacer for a liquid crystal display apparatus 11 (12) is to be formed. The ink for spacer formation is preferably discharged onto one of the substrate surfaces among the two mutually opposing substrates in the liquid crystal display apparatus, and the area in which the spacer is placed is preferably the non-display area such as the black matrix of a color filter.

For this embodiment the ink for spacer formation was printed on the substrate 23 and then heat treated to form a resin layer 20, but alternatively the resin layer 20 and resin layer 22 may be formed simultaneously by layered printing of the ink for spacer formation at the same location, without heat treatment after printing of the ink for spacer formation on the substrate 23, and following this by removal of the solvent by heat treatment or the like. Also, a resin layer may be further formed on the resin layer 22 by using an ink-jet method for further printing of the resin layer 22 with an ink containing a resin and a solvent and containing essentially no solid particles, followed by removal of the solvent. Thus, the ink may be printed in layers on the resin layer 22 and the solvent subsequently removed to form a spacer for a liquid crystal display apparatus comprising 3 or more resin layers on the substrate 23.

The ink for spacer formation used in the process for producing a spacer for a liquid crystal display apparatus will now be described in detail. In the process for producing a spacer for a liquid crystal display apparatus according to the invention, the ink used contains a resin and a solvent dissolving it, and contains essentially no solid particles. The phrase “contains essentially no” means that the content of solid particles with particle sizes of 1.0 μm and greater is less than 0.5 mass % with respect to the ink weight at ordinary temperature. The solid particle content is preferably less than 0.3 mass %, more preferably less than 0.05 mass % and most preferably less than 0.01 mass % with respect to the ink weight. Reducing the solid particle content can further improve the positional precision of impact.

The ink for spacer formation, or ink, of this embodiment preferably has the resin uniformly dissolved in the solvent. The phrase “resin uniformly dissolved” means that when the ink is filtered with a filter having an aperture of 1 μm at ordinary temperature, the solid content of the filtered spacer is less than 0.3 mass % with respect to the ink.

The viscosity of the ink for spacer formation according to this embodiment is preferably no greater than 50 mPa·s at 25° C. A viscosity of no greater than 50 mPa·s for the ink for spacer formation will more reliably prevent nozzle discharge interruption and nozzle clogging during ink jet printing. The viscosity of the ink for spacer formation is more preferably 1.0-30 mPa·s at 25° C. An ink viscosity in this range will tend to reduce the droplet size to allow further reduction in the ink impact diameter.

The vapor pressure of the solvent in the ink for spacer formation is preferably less than 1.34×10³ Pa at 25° C. Such a solvent can inhibit increase in the ink viscosity caused by volatilization of the solvent. If an ink with a vapor pressure of, for example, greater than 1.34×10³ Pa is used, the ink droplets will dry quickly and discharge of the droplets from the nozzle of the ink-jet head will be hampered, also tending to promote clogging of the ink-jet head. Limiting the vapor pressure of the solvent in the ink for spacer formation to less than 1.34×10³ Pa can avoid such inconveniences. A solvent with a vapor pressure of less than 1.34×10³ Pa and a solvent with a vapor pressure of 1.34×10³ Pa or greater may be used in combination, but in such cases the mixing proportion of the solvent with a vapor pressure of 1.34×10³ Pa or greater is preferably no greater than 60 mass %, more preferably no greater than 50 mass % and even more preferably no greater than 40 mass % based on the total weight of the solvent. The solvent may be any one whose vapor pressure is within the desired range and which can disperse or dissolve the insulating resin.

As solvents with vapor pressures of less than 1.34×10³ Pa at 25° C. there may be mentioned, specifically, γ-butyrolactone, cyclohexanone, N-methyl-2-pyrrolidone, anisole, ethyleneglycol monomethyl ether acetate, diethyleneglycol dimethyl ether, triethyleneglycol monomethyl ether, triethyleneglycol dimethyl ether, dipropyleneglycol monomethyl ether and tripropyleneglycol dimethyl ether. As specific solvents with a vapor pressure of 1.34×10³ Pa or greater at 25° C. there may be mentioned methyl ethyl ketone, methyl isobutyl ketone, toluene and isopropyl alcohol. These solvents may be used alone or in combinations of two or more.

The proportion of the solvent in the ink is not particularly restricted, and preferably it is appropriately adjusted so that the viscosity and surface tension of the ink at 25° C. are within the aforementioned specified ranges, although for most purposes it is preferred to be 50-99 mass % with respect to the ink weight.

The resin in the ink may be any one so long as it is a material that exhibits an electrical insulating property and can impart an adhesive property to the base material, and as examples there may be mentioned epoxy resins, phenol resins, polyimide resins, polyamide resins, polyamideimide resins, silicone-modified polyamideimide resins, polyester resins, cyanate ester resins, BT resins, acrylic resins, melamine resins, urethane resins and alkyd resins, without any particular restrictions to these. These may be used alone or in combinations of two or more different types.

When using a thermosetting resin as the resin, it may be used by first dissolving the monomer or oligomer in a solvent if necessary and printing it onto the substrate, and then heat treating it to remove the solvent and/or cure the resin. The ink for spacer formation may also contain a curing accelerator, coupling agent, antioxidant, filler or the like as necessary.

The thermosetting resin preferably comprises an epoxy resin and its curing agent, from the viewpoint of heat resistance. Examples of epoxy resins include bisphenol A-type epoxy resins, bisphenol F-type epoxy resins, bisphenol S-type epoxy resins, biphenol-type epoxy resins, alicyclic epoxy resins, aliphatic straight-chain epoxy resins, glycidyl ester-type epoxy resins, or glycidyl etherified condensation products of phenols such as phenol, cresol, alkylphenol, catechol, bisphenol F, bisphenol A and bisphenol S with aldehydes such as formaldehyde or salicylaldehyde, or glycidyl etherified polyphenols, as well as hydrogenated and halogenated forms of the foregoing, but from the viewpoint of heat resistance and adhesion a glycidyl etherified condensation product of a phenol and aldehyde is preferred. These epoxy resins may be of any molecular weight, and any number of different types may be used together.

As examples of curing agents to be used with the epoxy resin there may be mentioned amines such as diethylenetriamine, triethylenetetramine, metaxylenediamine, diaminodiphenylmethane, diaminodiphenylsulfone, m-phenylenediamine and dicyandiamide; acid anhydrides such as phthalic anhydride, tetrahydrophthalic anhydride, hexahydrophthalic anhydride, methyltetrahydrophthalic anhydride, methylhexahydrophthalic anhydride, methylnadic anhydride, pyromellitic anhydride and trimellitic anhydride; imidazoles such as imidazole, 2-ethylimidazole, 2-ethyl-4-methylimidazole, 2-phenylimidazole, 2-undecylimidazole, 1-benzyl-2-methylimidazole, 2-heptadecylimidazole, 4,5-diphenylimidazole, 2-methylimidazoline, 2-phenylimidazoline, 2-undecylimidazoline, 2-heptadecylimidazoline, 2-isopropylimidazole, 2,4-dimethylimidazole, 2-phenyl-4-methylimidazole, 2-ethylimidazoline, 2-isopropylimidazoline, 2,4-dimethylimidazoline and 2-phenyl-4-methylimidazoline; imidazoles having their imino groups masked with acrylonitrile, phenylene diisocyanate, toluidine isocyanate, naphthalene diisocyanate, methylenebisphenyl isocyanate, melamine acrylate or the like; phenols such as bisphenol F, bisphenol A, bisphenol S and polyvinylphenol; and condensation products of phenol compounds such as phenol, cresol, alkylphenol, catechol, bisphenol F, bisphenol A or bisphenol S with aldehyde compounds such as formaldehyde or salicylaldehyde, and halogenated forms of the foregoing. Preferred among these are condensation products of phenols and aldehydes, from the viewpoint of heat resistance and adhesion. These compounds may be of any molecular weight, and a single one may be used alone or two or more different ones may be used in combination.

The proportion of the insulating resin in the ink is preferably adjusted as appropriate so that the viscosity and surface tension of the ink at 25° C. are within the aforementioned specified ranges, although for most purposes it is preferred to be 1-50 mass % with respect to the ink weight.

A liquid crystal display apparatus according to the invention will now be described. The liquid crystal display apparatus of the invention is a liquid crystal display apparatus comprising a pair of mutually opposing substrates, a liquid crystal layer composed of a liquid crystal substance enclosed between the pair of substrates, and a spacer for a liquid crystal display apparatus situated between the substrates to maintain a consistent thickness for the liquid crystal layer. The spacer for a liquid crystal display apparatus is formed on a desired location of a substrate by an ink-jet method using an ink for spacer formation according to the invention as described above. Specifically, the spacer for a liquid crystal display apparatus can be formed by coating the ink for spacer formation at a desired location of the substrate using an ink jet printing device and heat treating it to cure the resin and/or remove the solvent.

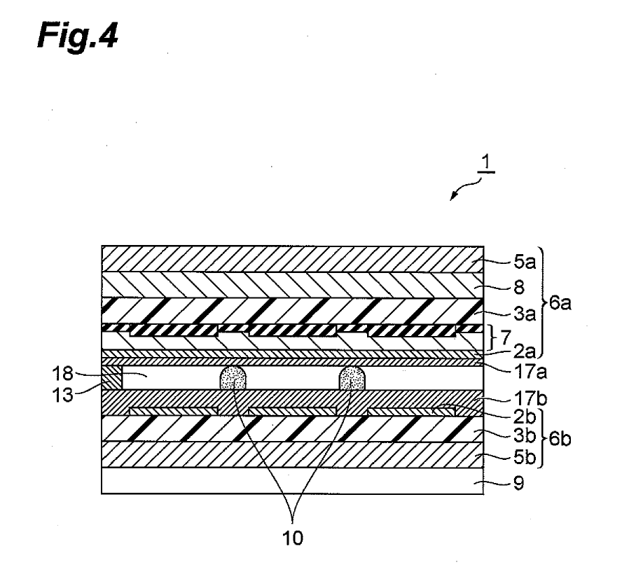

FIG. 4 is a schematic cross-sectional view of an embodiment of a liquid crystal display apparatus according to the invention. As shown in FIG. 4, the liquid crystal display apparatus 1 comprises a pair of substrate members 6a, 6b situated facing each other. The substrate member 6a comprises an electrode 2a, a color filter 7, a substrate 3a, a retardation film 8 and a polarizing plate 5a, laminated in that order. The substrate member 6b comprises an electrode 2b, a substrate 3b and a polarizing plate 5b, laminated in that order. A backlight 9 is situated on the external side of the polarizing plate 5b in the substrate member 6b. Also, orientation layers 17a, 17b are laminated on the sides of the substrate members 6a, 6b on which the electrodes 2a, 2b are formed. The liquid crystal layer 18 is sandwiched by the substrate members 6a, 6b via the orientation layers 17a, 17b. A sealant 13 is also provided between the substrate members 6a, 6b at the edges of the liquid crystal layer 18, serving to bond the substrate members 6a, 6b.

In this type of liquid crystal display apparatus, as shown in FIG. 4, the spacer 10 for a liquid crystal display apparatus is set at prescribed locations of the liquid crystal display apparatus 1 to ensure a consistent thickness for the liquid crystal layer 18. From the viewpoint of displaying high quality images, the spacer 10 for a liquid crystal display apparatus is preferably set at locations other than the display dots at the translucent sections.

The spacer 10 for a liquid crystal display apparatus is preferably set at equal spacings across the entire image display area. Since the spacer 10 for a liquid crystal display apparatus is formed by an ink jet printing method using an ink for spacer formation according to the invention, it is situated with sufficiently high positional precision across the entire screen display area and display defects such as display irregularities and light dropouts can be adequately prevented.

The liquid crystal display apparatus can be produced by a method in which the spacer 10 for a liquid crystal display apparatus is formed on the orientation layer 17b provided on the substrate 3b. The spacer 10 for a liquid crystal display apparatus may also be formed by two or more layered printings of the ink by the ink-jet method, to allow adjustment to the desired height.

The substrate members 6a, b shown in FIG. 4 have the structure with each of the laminated layers mentioned above, but they do not necessarily need to include all of the layers. If necessary, the substrate members 6a, b may further comprise an insulating layer, black matrix layer, shock-absorber layer, TFT and the like.

As the electrodes 2a, 2b there may be used transparent electrodes made of tin-doped indium oxide (ITO) or the like. Examples for the substrates 3a, 3b include plastic substrates, glass substrates and the like. Known materials may be used for the color filter 7, the retardation film 8, the polarizing plates 5a, 5b and the backlight 9. The orientation layers 17a, 17b may be formed using a known liquid crystal orienting agent.

### EXAMPLES

The present invention will now be explained in greater detail based on examples and comparative examples, with the understanding that the invention is in no way limited to the examples. The viscosities of the inks used in the examples and comparative examples were measured at 25° C. using a CJV5000 small oscillating viscometer, trade name of A&D Co., Ltd. Also, the surface tensions of the inks were measured at 25° C. using a surface tension measuring apparatus based on the Wilhelmy method (platinum plate method), and a fully automatic surface tension meter by Kyowa Interface Science Co., Ltd. (trade name: CBVP-Z). The surface free energy of the substrate was calculated by an acid-base method, after measuring the contact angle of water, formamide and glycerin on the substrate at 25° C. using an automatic contact angle meter by Kyowa Interface Science Co., Ltd. (trade name: DM500). The amount of the solid portion filtered out by filtration of the ink was determined by filtering the ink using a filter with an aperture of 1 μm at ordinary temperature, and measuring the weight of the filtered solid content after drying at 200° C. for 1 hour.

(Preparation of Ink 1)

Ink 1 was prepared by dissolving a bisphenol A-novolac-type epoxy resin (trade name: N-865 by Dainippon Ink and Chemicals, Inc.), a bisphenol A-novolac resin (trade name: VH4170 by Dainippon Ink and Chemicals, Inc.) and 2-ethyl-4-methylimidazole (product of Tokyo Kasei Kogyo Co., Ltd.) in γ-butyrolactone as the solvent (vapor pressure at 25° C.: 2.3×10² Pa). The proportions of each starting material and the solvent in ink 1 are shown in Table 1.

The viscosity of the prepared ink 1 was 8.4 mPa·s, the surface tension was 44 mN/m and the filtered solid content was 0.001 mass %.

(Preparation of Ink 2)

Ink 2 was prepared in the same manner as ink 1, except that the proportions of the starting materials and the solvent in the ink were changed as shown in Table 1.

The viscosity of the prepared ink 2 was 11.5 mPa·s, the surface tension was 44.1 mN/m and the filtered solid content was 0.001 mass %.

(Preparation of Ink 3)

Ink 3 was prepared in the same manner as ink 1, except that a silicone-based leveling agent (trade name: DISPARLON 1711, product of Kusumoto Chemicals, Ltd.) was added and the proportion of each starting material and the solvent were changed as shown in Table 1.

The viscosity of the prepared ink 3 was 7.6 mPa·s, the surface tension was 26 mN/m and the filtered solid content was 0.002 mass %.

(Preparation of Ink 4)

Ink 4 was prepared in the same manner as ink 1, except that the proportion of each starting material and the solvent were changed as shown in Table 1, and a particulate spacer (trade name: BD-380, product of Natoco Co., Ltd.) was added.

The viscosity of the prepared ink 4 was 12.2 mPa·s, the surface tension was 44 mN/m and the filtered solid content was 0.51 mass %.

TABLE 1

| | Ink type | | | |
|---|---|---|---|---|
| | 1 | 2 | 3 | 4 |
| Bisphenol A-novolac epoxy resin | 12.91 | 16.14 | 12.90 | 12.90 |
| Bisphenol A-novolac resin | 7.08 | 8.85 | 7.07 | 7.08 |
| 2-Ethyl-4-methylimidazole | 0.01 | 0.02 | 0.01 | 0.01 |
| γ-Butyrolactone | 80.00 | 75.00 | 79.92 | 79.51 |
| Silicon-based leveling agent | — | — | 0.10 | — |
| Particulate spacer | — | — | — | 0.50 |

Unit of every value is “mass %”.
“—” in column represents “not contained”.

### Example 1

The extraneous material was removed from ink 1 by filtration with a membrane filter having an aperture of 20 μm. Ink 1 from which the extraneous material had been removed was supplied to a piezo-type ink-jet apparatus equipped with a 50 μm-caliber head (trade name: Nanoprinter 1000, product of Microjet Corp.).

[Printing of Ink for Spacer Formation and Formation of Spacer]

The ink-jet apparatus was used to print ink 1 on the surface of a substrate obtained by forming a VA liquid crystal oriented film on a glass plate (surface free energy: 29 mJ/m²) based on discharge position coordinates (target), with an interval of 150 μm and a droplet volume of 15 pL. After one printing of ink 1, the substrate was quickly transferred onto a hot plate that had been heated to 180° C., and was dried and hardened for 30 minutes to form a spacer. The properties of the ink and substrate used are shown in Table 2.

[Evaluation of Positional Precision of Impact]

The coordinates of the impact positions were specified from an image of the printing condition of the ink dots printed on the substrate (before drying). The shift (W) between these coordinates and the original discharge position coordinates (target) was calculated and the positional precision of impact was evaluated based on the following evaluation criteria (n=80). The evaluation results were as shown in Table 3.

<Evaluation Criteria for Positional Precision of Impact>

A: At least 90% of the ink dots were within an impact position shift (W) of 25 μm, with respect to all of the printed ink dots.

B: Less than 90% of the ink dots were within an impact position shift (W) of 25 μm, with respect to all of the printed ink dots.

[Evaluation of Adhesiveness]

After firmly contact bonding commercially available cellophane tape onto the formed spacer, the cellophane tape was rapidly peeled and the presence of peeled spacer was confirmed to evaluate the adhesiveness. The evaluation criteria for the adhesiveness were as follows. The evaluation results for the adhesiveness were as shown in Table 3.

<Evaluation Criteria for Adhesiveness>

A: Absolutely no peeling of spacer in tape test.

B: At least partial peeling of spacer in tape test.

[Evaluation of Spacer Average Height and Standard Deviation]

The height of the formed spacer was measured using a three-dimensional non-contact surface shape measurement system (trade name: MM-3500) by Ryoka Systems, Inc. (n=96), and the average value and standard deviation for the measured values were determined.

[Evaluation of Spacer Diameter]

The diameter of the formed spacer was measured by observation under a microscope.

### Example 2

A spacer was formed on a substrate surface and evaluated in the same manner as Example 1, except that ink 2 was used instead of ink 1. The properties of the ink and substrate used are shown in Table 2. The evaluation results were as shown in Table 3.

### Example 3

A spacer was formed on a substrate and evaluated in the same manner as Example 1, except that the substrate used was obtained by forming a VA liquid crystal oriented film with a surface free energy of 35 mJ/m² on the glass plate instead of the VA liquid crystal oriented film with a surface free energy of 29 mJ/m². The properties of the ink and substrate used are shown in Table 2. The evaluation results were as shown in Table 3.

### Example 4

A spacer was formed on a substrate and evaluated in the same manner as Example 3, except that the droplet volume discharged in the ink-jet method was 35 pL. The properties of the ink and substrate used are shown in Table 2. The evaluation results were as shown in Table 3.

### Example 5

A spacer was formed on a substrate surface and evaluated in the same manner as Example 1, except that ink 3 was used instead of ink 1. The properties of the ink and substrate used are shown in Table 2. The evaluation results were as shown in Table 3.

### Example 6

A spacer was formed on a substrate and evaluated in the same manner as Example 5, except that the substrate used was obtained by forming a VA liquid crystal oriented film with a surface free energy of 35 mJ/m² on the glass plate instead of the VA liquid crystal oriented film with a surface free energy of 29 mJ/m². The properties of the ink and substrate used are shown in Table 2. The evaluation results were as shown in Table 3.

### Comparative Example 1

A spacer was formed on a substrate and evaluated in the same manner as Example 5, except that the substrate used was obtained by forming a TN liquid crystal oriented film with a surface free energy of 43 mJ/m² on the glass plate instead of the VA liquid crystal oriented film with a surface free energy of 29 mJ/m². The properties of the ink and substrate used are shown in Table 2. The evaluation results were as shown in Table 3.

### Comparative Example 2

A spacer was formed on a substrate and evaluated in the same manner as Example 5, except that the substrate used was obtained by forming an IPS liquid crystal oriented film with a surface free energy of 53 mJ/m² on the glass plate instead of the VA liquid crystal oriented film with a surface free energy of 29 mJ/m². The properties of the ink and substrate used are shown in Table 2. The evaluation results were as shown in Table 3.

### Comparative Example 3

A spacer was formed on a substrate and evaluated in the same manner as Comparative Example 1, except that ink 4 was used instead of ink 1 and ink 4 was not filtered with a membrane filter. The properties of the ink and substrate used are shown in Table 2. The evaluation results were as shown in Table 3.

TABLE 2

| | Ink | | | Substrate | | | |
|---|---|---|---|---|---|---|---|
| | | | Surface | | Surface | A (*2) | Droplet |
| | | Dry solid | tension | | free energy | (mM/m = | volume |
| | Type | content | (mN/m) | Type (*1) | (mJ/m²) | mJ/m²) | (pL) |
| Example 1 | 1 | 20 | 44 | 1 | 29 | 15 | 15 |
| Example 2 | 2 | 25 | 44 | 1 | 29 | 15 | 15 |
| Example 3 | 1 | 20 | 44 | 2 | 35 | 9 | 15 |
| Example 4 | 1 | 20 | 44 | 2 | 35 | 9 | 35 |
| Example 5 | 3 | 20 | 26 | 1 | 29 | −3 | 15 |
| Example 6 | 3 | 20 | 26 | 2 | 35 | −9 | 15 |
| Comp. Ex. 1 | 3 | 20 | 26 | 3 | 43 | −17 | 15 |
| Comp. Ex. 2 | 3 | 20 | 26 | 4 | 54 | −28 | 15 |
| Comp. Ex. 3 | 4 | 20 | 44 | 3 | 43 | 1 | 15 |

(*1) 1 = VA liquid crystal orienting film, 2 = VA liquid crystal orienting film, 3 = TN liquid crystal orienting film, 4 = IPS liquid crystal orienting film (formed on each surface).
(*2) A is the value calculated by (Surface tension − Surface free energy)

TABLE 3

| | | Spacer | | | | |
|---|---|---|---|---|---|---|
| | Spacer | height | | Spacer | | |
| | height | standard | Spacer | diameter/ | Positional | |
| | average | deviation | diameter | spacer | precision of | |
| | (μm) | (μm) | (μm) | height | impact | Adhesiveness |
| Example 1 | 4.9 | 0.09 | 31 | 6 | A | A |
| Example 2 | 5.4 | 0.13 | 35 | 6 | A | A |
| Example 3 | 4.0 | 0.08 | 33 | 8 | A | A |
| Example 4 | 6.2 | 0.12 | 44 | 7 | A | A |
| Example 5 | 3.5 | 0.03 | 39 | 11 | A | A |
| Example 6 | 2.8 | 0.03 | 44 | 16 | A | A |
| Comp. Ex. 1 | 0.78 | 0.03 | 85 | 109 | A | A |
| Comp. Ex. 2 | 0.47 | 0.04 | 91 | 194 | A | A |
| Comp. Ex. 3 | 3.5 | 0.09 | 31 | 105 | B | A |

The average heights of the spacers formed in Examples 1-6 were in the range of 1-10 μm, and the positional precisions of impact were satisfactory. Based on the results for Examples 1-6, limiting the difference between the ink surface tension and the substrate surface energy (value A in Table 2) to the range of −10 to 15 allowed the spacer height to be adjusted within a suitable range for a spacer for a liquid crystal display apparatus. The adhesiveness between each of the spacers and substrates formed in each of the examples was also satisfactory.

On the other hand, the average heights of the spacers formed in Comparative Examples 1 and 2 were both low at less than 1 μm. Also, the positional precision of impact was poor in Comparative Example 3.

### INDUSTRIAL APPLICABILITY

According to the invention it is possible to provide a process for producing a liquid crystal display spacer that can form a liquid crystal display spacer with sufficient height and satisfactorily excellent positional precision and height precision. The invention can also provide an ink for spacer formation that can be suitably used in the aforementioned production process, as well as a liquid crystal display apparatus comprising a spacer for a liquid crystal display apparatus formed by the production process and a method for manufacturing the same.

1. A process for producing a spacer for a liquid crystal display apparatus, comprising:
printing droplets composed of an ink that contains a resin and a solvent that dissolves it but that contains essentially no solid particles on a substrate by an ink-jet method, and
removing the solvent from the droplets on the substrate to form a spacer situated at a prescribed location on the substrate,
wherein A in the following formula (1) is −10 to 15 mJ/m², where X mN/m is the surface tension of the ink at 25° C. and Y mJ/m² is the surface free energy of the substrate at 25° C.
A=X−Y (1)

2. The process for producing a spacer for a liquid crystal display apparatus according to claim 1, wherein A in formula (1) is varied within the range of −10 to 15 mJ/m² to adjust the height H of the spacer.

3. The process for producing a spacer for a liquid crystal display apparatus according to claim 1, wherein the surface tension of the ink at 25° C. is 20 mN/m or greater and the viscosity of the ink at 25° C. is no greater than 50 mPa·s.

4. The process for producing a spacer for a liquid crystal display apparatus according to claim 1, wherein the vapor pressure of the solvent at 25° C. is less than 1.34×10³ Pa.

5. The process for producing a spacer for a liquid crystal display apparatus according to claim 1, wherein the resin is a thermosetting resin and the droplets are heated on the substrate to remove the solvent from the droplets while curing the thermosetting resin, thus forming the spacer for a liquid crystal display apparatus.

6. The process for producing a spacer for a liquid crystal display apparatus according to claim 5, wherein the thermosetting resin comprises an epoxy resin and its curing agent.

7. The process for producing a spacer for a liquid crystal display apparatus according to claim 6, wherein the epoxy resin is a glycidyl etherified condensation product of a phenol compound and an aldehyde compound.

8. The process for producing a spacer for a liquid crystal display apparatus according to claim 1, wherein the filtered solid content of the ink when it has been filtered with a 1 μm aperture filter is less than 0.3 mass % with respect to the ink.

9. The process for producing a spacer for a liquid crystal display apparatus according to claim 1, wherein the height H of the spacer is adjusted by varying the solid content of the dried ink.

10. The process for producing a spacer for a liquid crystal display apparatus according to claim 1, wherein the height H of the spacer is adjusted by varying the volume of droplets printed on the substrate.

11. An ink for spacer formation for a liquid crystal display apparatus, which is printed on a substrate by an ink-jet method, the ink comprising:
a resin; and
a solvent that dissolves it but contains essentially no solid particles,
wherein A in the following general formula (1) is −10 to 15 mJ/m², where X mN/m is the surface tension of the ink at 25° C. and Y mJ/m² is the surface free energy of the substrate at 25° C.
A=X−Y (1)

12. A process for producing a liquid crystal display apparatus that comprises a pair of mutually opposing substrates and a liquid crystal layer and a spacer for a liquid crystal display apparatus situated between the pair of substrates, the process comprising a step of forming the spacer for a liquid crystal display apparatus on at least one of the substrates by the production process according to claim 1.

13. A liquid crystal display apparatus comprising:
a pair of mutually opposing substrates; and
a liquid crystal layer and a spacer for a liquid crystal display apparatus situated between the pair of substrates, the spacer for a liquid crystal display apparatus being formed by the production process according to claim 1.
